(19) United States
(12) Patent Application Publication
(10) Pub. No.: US 2008/0155594 A1
(43) Pub. Date: Jun. 26, 2008

(54) Faster Tunning Using Multiple Tuners Andnetworked Monitors

(75) Inventors: Hendrikus G. Van Horck, Eindhoven (NL); Martinus S. Nielen, Best (NL); Ren Lin, Breda (NL); Sander R. Kooijmans, Shoven (NL); Johan M. Spanjers, Eindhoven (NL); Todor V. Todorov, Eindhoven (NL); Wilhelmus G. Nitert, Eindhoven (NL); Thomas P. John, Veldhoven (NL); Petrus N. Wouters, Oostelbeers (NL); Piotr L. Sawicki, Eindhoven (NL); Rani M. Joseph, Veldhoven (NL); Marcus G.A. Haarsma, Wageningen (NL); Hendrik F. Moll, Geldrop (NL); Stuart Burge, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,805

(22) PCT Filed: Feb. 3, 2006
(86) PCT No.: PCT/IB2006/050371

§ 371 Date: Jul. 26, 2007

Related U.S. Application Data
(60) Provisional application No. 60/649,810, filed on Feb. 3, 2005.

(51) Int. Cl. H04N 5/445; H04N 5/50

(52) U.S. Cl. 725/38; 348/731; 348/E05.097

(57) ABSTRACT

Multiple television monitors (160, 170, 360, 370) share access via a network (150) to a central tuning device (100) that is able to tune multiple channels concurrently. The monitors communicate channel requests to the central device via the network. The central device processes the requests by controlling a number of individual tuners (330, 335, 340) to tune the requested channels, and couples the monitors to a data stream that is output from the appropriate individual tuner. Predictive tuning may be performed with any unused tuners to reduce delays. The monitors decode (425) the received data streams. Optionally, decoders (130, 135, 140) are provided for each tuner at the central device so that a decoded data stream is provided to the monitors.

The invention relates generally to a method and system for tuning and decoding a television data stream and, more particularly, to an arrangement where multiple television monitors share access via a network to a central tuning and decoding device that is able to tune and decode multiple channels concurrently.

Digital television communications have become increasingly popular because they provide the viewer with high quality video and audio data, as well as various interactive features and an increased number of programming choices. Such communications currently are provided via satellite, digital cable and terrestrial broadcasts, for instance. Compression schemes such as used in the MPEG standard are used to eliminate redundancies in the data and to reduce the amount of data that must be transmitted. However, the encoding involves a number of steps and is relatively computationally intensive. At the receiver, such as a set-top box, decoding must be performed to reverse the steps performed by the encoding. The decoding therefore is also computationally intensive.

In the tuning process, the digital television receiver locks a tuner on to the pilot signal of the RF digital television signal, and demodulates the RF television signal to produce a baseband encoded television signal. Next, in the decoding process, forward error correction coding is processed to recover transport packets. The transport packets are then processed to reproduce packetized elementary stream (PES) packets, and the PES packets are processed to reproduce an elementary bit-stream. The elementary bit-stream for the video signal is applied to a variable length decoder and run-length decoder that produce fixed length code values representing frequency domain coefficients as well as other side information, such as motion vectors, that are needed to decode the video signal. The fixed length coefficient values are applied to an inverse quantizer and to an inverse discrete cosine transform processor to reproduce pixel values.

Moreover, for motion compensated frames, the pixel values are differential pixel values that are referenced to a pixel values in a prior frame or field as indicated by a motion vector. The pixels represented by the motion vector are recovered and added to the differential pixels in order to reproduce the video signal. Comparable digital encoding techniques are used for the audio portion of the television signal.

The complex coding scheme used for digital television programming produces great coding efficiency but causes delays in the reproduction of a video or audio signal. For example, the time between when a television tuner is first tuned to a digital television channel and the time that the video information is displayed may be as long as one to four seconds. Such delays are inconvenient when the viewer wishes to “channel surf” by successively tuning one channel after another in order to find a program that is of interest.

Some systems attempt to avoid such delays by providing a television with more than one tuner, or by predictively buffering channels. However, such approaches add significant costs to each television or set-top appliance. Moreover, the known approaches do not take advantage of available in-home networking technologies.

The present invention addresses the above and other issues by providing an arrangement where multiple television monitors share access via a network to a central device that is able to tune and, optionally, decode, multiple channels concurrently. In particular, the monitors communicate channel requests to the central device via the network. The central device processes the requests by controlling a number of individual tuners to tune the requested channels, and couples the monitors to a data stream that is output from the appropriate tuner. The monitor then decodes the data stream to recover data of the desired channel. Alternatively, decoders are provided for each tuner at the central device so that a decoded data stream is provided to the monitors.

In one aspect of the invention, a method is provided for allowing a plurality of monitors to share access to a plurality of tuners in a central location, wherein each of the tuners is capable of performing tuning of a data stream received at the central location. The method includes: (a) receiving respective requests from each of the plurality of monitors for viewing a respective channel, (b) controlling at least a subset of the plurality of tuners, responsive to the respective requests, to tune the respective channels, and (c) coupling each of the plurality of monitors to a data stream that is output from the tuner which is being controlled to tune the respective channel requested thereby.

In another aspect of the invention, a method is provided for allowing a plurality of monitors to share access to a plurality of tuning and decoding units in a central location, wherein each of the tuning and decoding units is capable of performing tuning and decoding of a data stream received at the central location. The method includes: (a) receiving respective requests from each of the plurality of monitors for viewing a respective channel, (b) controlling at least a subset of the plurality of tuning and decoding units, responsive to the respective requests, to tune and decode the respective channels, and (c) coupling each of the plurality of monitors to the tuning and decoding unit which is being controlled to tune and decode the respective channel requested thereby.

Corresponding data processing systems, tuning and decoding devices, and monitors, are also provided. Corresponding program storages devices may also be provided.

In the drawings:

In all the Figures, corresponding parts are referenced by the same reference numerals.

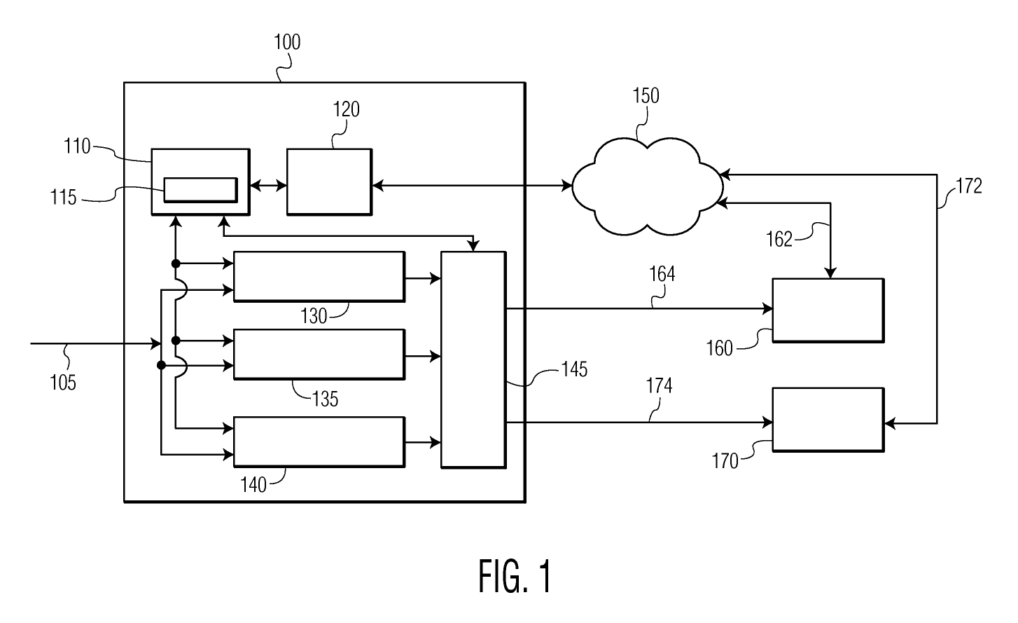

FIG. 1 illustrates a block diagram of data processing system including a central tuning and decoding device and a number of monitors, according to the invention;

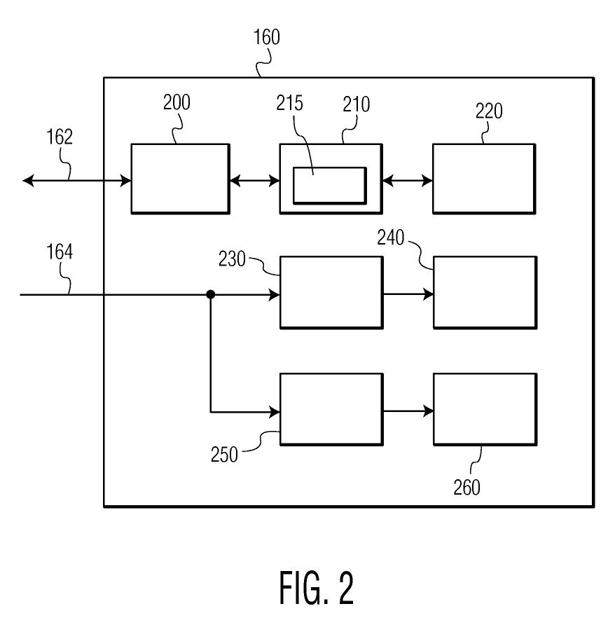

FIG. 2 illustrates a block diagram of an example monitor for use with the system of FIG. 1, according to the invention;

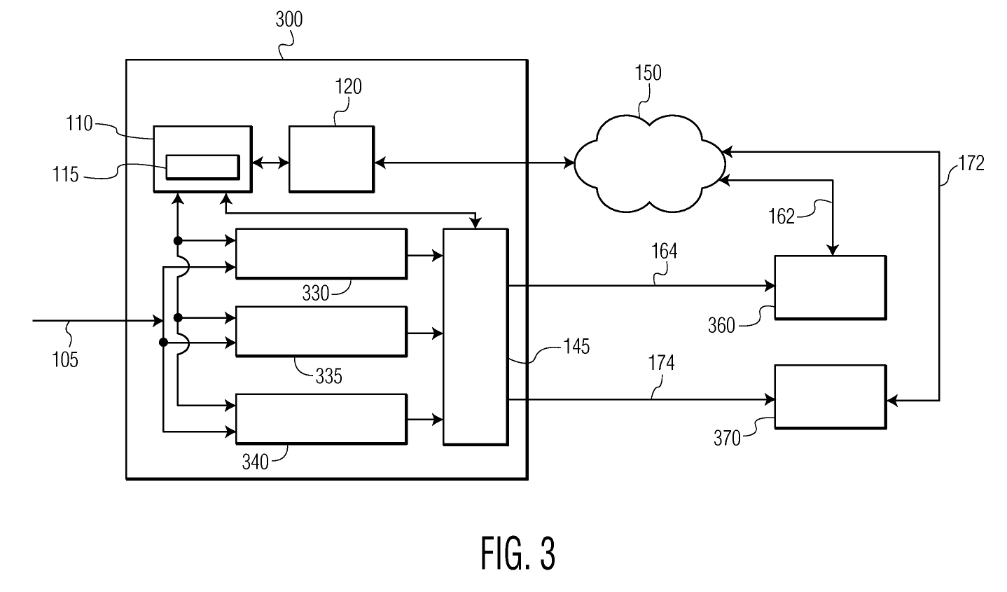

FIG. 3 illustrates a block diagram of data processing system including a central tuning device and a number of monitors, according to the invention; and

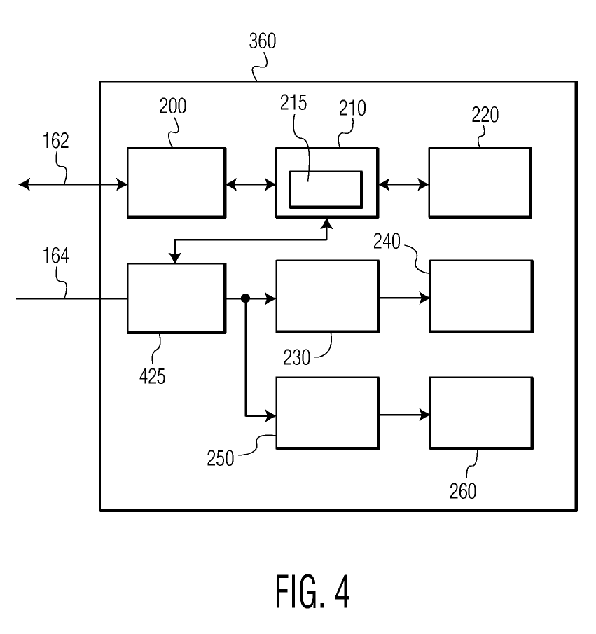

FIG. 4 illustrates a block diagram of an example monitor for use with the system of FIG. 3, according to the invention.

A block diagram of an example data processing system including a central tuning and decoding device and a number of monitors is provided in FIG. 1. Block 100 reads “Tuning and Decoding Device”. Path 105 reads “Data Multiplex”. Block 110 reads “Processor”. Block 115 reads “Memory”. Block 120 reads “Network interface”. Block 130 reads “Tuning and decoding unit U1”. Block 135 reads “Tuning and decoding unit U2”. Block 140 reads “Tuning and decoding unit U3”. Block 145 reads “Switching device”. Cloud 150 reads “Network”. Block 160 reads “Monitor M1”. Block 170 reads “Monitor M2”.

A central tuning and decoding device 100 may be provided in an information appliance such as a set-top box or television. The tuning and decoding device 100 includes a processor 110 with memory 115. Generally, the tuning and decoding device 100 includes memory and processing resources for implementing the functionality described herein. In particular, at least one program storage device may tangibly embody instructions, such as software, firmware and/or micro code, which are executed by at least one processor, such as processor 110, to achieve the functionality described herein. A memory that stores the instructions, such as memory 115, may be considered a program storage device.

A network interface 120, such as a network interface card, allows the tuning and decoding device 100 to communicate with a number of television monitors or other display monitors, such as monitor M1 (160) and monitor M2 (170), via a network 150. For example, a Universal Plug and Play (UPnP) network may be used. Generally, any time of network can be used, including those using proprietary protocols. Data from a multiplexed data stream received via a path 105 is provided to each of individual tuning and decoding units U1 (130), U2 (135) and U3 (140), for instance. Generally, the number of tuning and decoding units is the same as, or greater than, the number of monitors which access the tuning and decoding device 100. Each tuning and decoding unit has the ability to tune and decode at least one channel of data for use by a monitor.

For example, the received data stream may include a number of transport streams in different frequency bands, where each transport stream has a data rate of up to, e.g., 40 megabits per second, which is enough for seven or eight separate TV channels. Each transport stream includes a set of sub-streams known as elementary streams, where each elementary stream can contain either MPEG-2 encoded audio, MPEG-2 encoded video, or data encapsulated in an MPEG-2 stream, for instance. Each of these elementary streams has a packet identifier (PID) that acts as a unique identifier for that stream within the transport stream. Individual TV channels, also known as services, can be identified using service information (SI) carried in the data stream.

Note that the invention can be adapted for use with analog transmissions as well.

The tuning and decoding units U1 (130), U2 (135) and U3 (140) may be controlled by the processor 110 to tune and decode a specified TV channel.

A switching device 145 is controlled by the processor 110 to couple an output of each of the tuning and decoding units U1 (130), U2 (135) and U3 (140) to the appropriate monitor to provide the requested TV program. Multiple monitors may be coupled to one of the tuning and decoding units when they request the same channel. Furthermore, it is possible for multiple tuning and decoding units to be coupled to one monitor, such as when the monitor is viewing multiple channels concurrently such as using a split-screen or picture-in-picture feature.

Furthermore, when one or more of the tuning and decoding units is not being used to tune and decode a currently requested channel, the one or more of the tuning and decoding units may be used to predictively tune and decode a channel for at least one of the monitors. Such predictive tuning and decoding can use various approaches. For example, the processor 110 can note the channel selections made over time for each monitor to determine which channels are most frequently selected, and which channel selection or surfing sequences are most frequently made by a monitor. For example, the sequence of channels 2, 5 and 8 may be common for one of the monitors, such as a monitor in a bedroom of a home that is used by one viewer. In this case, if channel 2 is selected, and then channel 5, channel 8 can be predictively tuned and decoded since it is likely the viewer will request channel 8 next.

The predictive tuning and decoding can be adjusted as the monitors are no longer used, or as additional monitors are used. To this end, the monitors 160 and 170 may communicate data to the tuning and decoding device 100 via the network 150 indicating their status, e.g., whether they are on or off. As an example, if there are three monitors in use and three tuning and decoding units are in use tuning and decoding different channels, predictive tuning and decoding generally cannot be used. If one of the monitors is switched off, one of the tuning and decoding units becomes available for predictive tuning and decoding. Similarly, assume there are two monitors in use and two tuning and decoding units in use tuning and decoding different currently requested channels, e.g., a subset of the three tuning and decoding units provided, and one tuning and decoding unit in use performing predictive tuning and decoding. Then, if a third monitor is switched on and requests a channel, the tuning and decoding unit that was performing predictive tuning and decoding can be controlled instead to tune and decode the currently requested channel of the third monitor.

Various statistical techniques may be employed to determine an optimum predictive tuning and decoding scheme. Furthermore, when there are multiple viewers that use a monitor, and the current viewer that is controlling the monitor can be identified, such as via a user interface of the monitor, the processor 110 can use this information to optimize the predictive tuning based on the particular viewer's previous channel selection habits. Generally, the processor 110 may execute an algorithm for determining which tuning and decoding units should be controlled to service which current channel requests from the monitors, and which should be controlled to perform predictive tuning and decoding in anticipation of future channels requests.

Optionally, a tuning and decoding device can send a multiplex of channels to a monitor, in which case the monitor includes components for demultiplexing the multiplex to recover one or more desired channels. This approach requires that additional bandwidth is available for transmitting the multiplex to the monitors, e.g., on paths 164 and 174.

The network interface 120 provides the channel requests received from the monitors 160 and 170 to the processor 110. The channel requests may be provided via communication paths 162 and 172, for example. These paths 162 and 172 can be any type of network path, including wired and wireless. Different communication paths 164 and 174 are provided for coupling the monitors 160 and 170, respectively, to the switching device 145 to receive the requested channel data. These paths 164 and 174 can be any type of communication path, although a hardwired path such as coaxial cable is believed to offer the lowest cost. For example, the tuning and decoding device 100 can be a set-top appliance that is provided in a central location in a home, while the monitors 160 and 170 are provided in different rooms in the home, and connected to the set-top appliance by cable. One of the monitors may be provided near the tuning and decoding device 100 as desired, or the tuning and decoding device 100 can be incorporated into a television.

FIG. 2 illustrates a block diagram of an example monitor, according to the invention. Path 162 reads “To/from network”. Path 164 reads “From tuner and decoder device”. Block 200 reads “network interface”. Block 210 reads “Processor”. Block 215 reads “Memory”. Block 220 reads “User interface”. Block 230 reads “Display driver”. Block 240 reads “Display. Block 250 reads “Audio driver.” Block 260 reads “Speaker”.

The example monitor 160 includes a network interface 200, such as a network interface card, for communicating to and/or from the network 150 via a path 162. A processor 210 having a memory 215 interacts with the network interface 200 and a user interface 220. Generally, the monitor 160 includes memory and processing resources for implementing the functionality described herein. In particular, at least one program storage device may tangibly embody instructions, such as software, firmware and/or micro code, which are executed by at least one processor, such as processor 210, to achieve the functionality described herein. A memory that stores the instructions, such as memory 215, may be considered a program storage device.

The user interface 220 receives commands from a viewer, such as a request to view a channel. For example, the viewer may operate a hand held remote control for requesting a channel. Or, the viewer may request a channel using an on-screen electronic program guide. The processor 210 provides a message with the channel request to the network interface 200 for communication via the network 150 to the tuning and decoding device 100 via its respective network interface 120. The processor 210 may provide other data to the tuning and decoding device 100 from time to time such as data indicating a history of channel selections made over time. The identity of the viewer that is currently controlling the monitor 160 may also be provided. This information can be provided at the time it is learned, such as when the viewer first interacts with the monitor, in which case the information can be stored at the tuning and decoding device 100 for subsequent use, e.g., for predictive tuning and decoding, and/or the identity of the current viewer can accompany each channel request that is communicated to the tuning and decoding device 100.

The monitor 160 receives a signal carrying the request channel via the communication path 164. The signal is processed by a display driver 230 to provide a video data portion of the signal in a format that is suitable for use by a display 240, and by an audio driver 250 to provide an audio data portion of the signal in a format that is suitable for use by a speaker 260. The signal received via the communication path 164 may alternatively include only video or audio data, or may include other types of data such as for playing a video game, data from an information services such as a stock ticker, and so forth. Furthermore, as mentioned, more than one channel of data may be received by the monitor 160, such as for providing a split-screen or picture-in-picture display, in which case additional components are provided as needed to process each channel.

In an alternative approach, tuning is performed at a central tuning device while decoding is performed at each monitor. This approach can provide the advantage of reduced channel display time since predictive tuning can be performed, although the reduction is less than when centralized decoding is performed. The decoding cost is shifted from the central device to the monitors. However, the cost benefit to the monitors due to providing central tuners is maintained. Moreover, a further significant advantage is that the amount of bandwidth required to transmit the still-encoded data to the monitors via the network is less than for transmitting decoded data.

FIG. 3 illustrates a block diagram of data processing system including a central tuning device and a number of monitors, according to the invention. FIG. 3 is analogous to FIG. 1, and the discussion provided in connection with FIG. 1 applies to the embodiment of FIG. 3 as well except as otherwise indicated. In FIG. 3, a centralized tuning device 300 includes individual tuners T1 (330), T2 (335) and T3 (340), which have the ability to tune at least one channel of data for use by a monitor. The output of each tuner 330, 335 and 340 is a data stream, such as a baseband multiplex carrying data of multiple channels.

The tuners 330, 335 and 340 are controlled by the processor 110 to tune a specified TV channel. The switching device 145 is controlled by the processor 110 to couple an output data stream of each of the tuners 330, 335 and 340 to the appropriate monitor to provide the requested TV program. Multiple monitors may be coupled to one of the tuners when they request the same channel. Furthermore, it is possible for multiple tuners to be coupled to one monitor, such as when the monitor is viewing multiple channels concurrently such as using a split-screen or picture-in-picture feature. Furthermore, when one or more of the tuners is not being used to tune a currently requested channel, the one or more of the tuners may be used to predictively tune a channel for at least one of the monitors. Such predictive tuning can use various approaches as discussed previously.

The predictive tuning can be adjusted as the monitors are no longer used, or as additional monitors are used. To this end, the monitors 360 and 370 may communicate data to the tuning device 100 via the network 150 indicating their status, e.g., whether they are on or off.

FIG. 4 illustrates a block diagram of an example monitor for use with the system of FIG. 3, according to the invention. FIG. 4 is analogous to FIG. 2, and the discussion provided in connection with FIG. 2 applies to the embodiment of FIG. 4 as well except as otherwise indicated. The example monitor 360 adds a decoder 425 for decoding the data stream that is received from the tuning device 300 via the path 164 to recover data of the requested channel. The decoder 425 may be an MPEG2 decoder, for instance. The processor 210 may communicate with the decoder 425 to inform the decoder 425 of the requested channel, such as by providing the channel number to the decoder 425. An output signal from the decoder 425 is processed by the display driver 230 to provide a video data portion of the signal in a format that is suitable for use by a display 240, and by an audio driver 250 to provide an audio data portion of the signal in a format that is suitable for use by a speaker 260, as discussed previously.

Advantageously, the present invention allows monitors to share access to a central device that performs either tuning, or tuning and decoding, so the monitors do not need their own tuning and/or decoding components. Moreover, if there are extra tuners, or tuning and decoding units, available in the central device that are not currently being used, they can be used for predictive tuning, or tuning and decoding, for one or more of the monitors.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for allowing a plurality of monitors to share access to a plurality of tuners in a central location (300), wherein each of the tuners is capable of performing tuning of a data stream (105) received at the central location, comprising:
receiving respective requests from each of the plurality of monitors (360, 370) for viewing a respective channel;
controlling at least a subset of the plurality of tuners (330, 335, 340), responsive to the respective requests, to tune the respective channels; and
coupling (145) each of the plurality of monitors to a data stream that is output from the tuner which is being controlled to tune the respective channel requested thereby.

2. The method of claim 1, further comprising:
controlling at least one of the tuners that is not currently used to tune any of the respective channels to predictively tune a channel for at least one of the plurality of monitors.

3. The method of claim 1, wherein:
the respective requests are received via a network (150).

4. The method of claim 1, further comprising:
processing (110) the respective requests at the central location by executing an algorithm for performing the controlling of the at least a subset of the plurality of tuners and the coupling.

5. The method of claim 1, wherein:
the data stream comprises a digital multiplex in which individual channels of data are carried; and
each the tuners is capable of performing tuning of the digital multiplex.

6. The method of claim 1, wherein:
each of the plurality of monitors receives and decodes (425) the data stream that is output from the tuner which is being controlled to tune the respective channel requested thereby.

7. A data processing system, comprising:
a central tuning device (300) comprising a plurality of tuners (330, 335, 340), wherein each the tuners is capable of performing tuning of a data stream (105) received by the central tuning device;
a network interface (120) associated with the central tuning device;
a plurality of monitors (360, 370); and
respective network interfaces (210) associated with each of the plurality of monitors; wherein:
each of the plurality of monitors transmits a respective request for viewing a respective channel via their respective network interface to the network interface associated with the central tuning device;
the central tuning device controls at least a subset of the plurality of tuners, responsive to the respective requests, to tune the respective channels; and
the central tuning device couples (145) each of the plurality of monitors to a data stream that is output from the tuner which is being controlled to tune the respective channel requested thereby.

8. The data processing system of claim 7, wherein:
the central tuning device controls at least one of the tuners that is not currently used to tune any of the respective channels to predictively tune a channel for at least one of the plurality of monitors.

9. The data processing system of claim 7, wherein:
each of the plurality of monitors decodes (425) the data stream that is output from the tuner which is being controlled to tune the respective channel requested thereby.

10. A central tuning device, comprising:
a plurality of tuners (330, 335, 340), wherein each the tuners is capable of performing tuning of a data stream (105) received by the tuner;
a network interface (120); and
a processor (110); wherein:
the network interface receives, via a network (150), respective requests from each of a plurality of monitors (360, 370) for viewing a respective channel; and
the processor executes an algorithm for controlling at least a subset of the plurality of tuners, responsive to the respective requests, to tune the respective channels, and to couple (145) each of the plurality of monitors to a data stream that is output from the tuner which is being controlled to tune the respective channel requested thereby.

11. The central tuning device of claim 10, wherein:
the processor controls at least one of the tuners that is not currently used to tune any of the respective channels to predictively tune a channel for at least one of the plurality of monitors.

12. The central tuning device of claim 10, wherein:
the data stream comprises a digital multiplex in which individual channels of data are carried; and
each the tuners is capable of performing tuning of the digital multiplex.

13. The central tuning device of claim 10, wherein:
each of the plurality of monitors decodes (425) the data stream that is output from the tuner which is being controlled to tune the respective channel requested thereby.

14. A monitor (360, 370), comprising:
a user interface (220) for receiving a user command to view a channel;
a processor (210);
a display (240); and
a network interface (200); wherein:
the processor is responsive to the user command received via the user interface for transmitting a request for viewing the channel via the network interface to a central tuning device (300) via a network (150); and
the monitor receives a data stream (164) that is output from a tuner (330, 335, 340) of the central tuning device, decodes the data stream to recover data of the channel, and displays the data of the channel on the display.

15. A method for allowing a plurality of monitors to share access to a plurality of tuning and decoding units in a central location, wherein each of the tuning and decoding units is capable of performing tuning and decoding of a data stream received at the central location, comprising:
receiving respective requests from each of the plurality of monitors (160, 170) for viewing a respective channel;
controlling at least a subset of the plurality of tuning and decoding units (130, 135, 140), responsive to the respective requests, to tune and decode the respective channels; and
coupling (145) each of the plurality of monitors to the tuning and decoding unit which is being controlled to tune and decode the respective channel requested thereby.

16. The method of claim 15, further comprising:
controlling at least one of the tuning and decoding units that is not currently used to tune and decode any of the respective channels to predictively tune and decode a channel for at least one of the plurality of monitors.

17. A data processing system, comprising:
a tuning and decoding device (300) comprising a plurality of tuning and decoding units (330, 335, 340), wherein each the tuning and decoding units is capable of performing tuning and decoding of a data stream (105) received by the tuning and decoding device;
a network interface (120) associated with the tuning and decoding device;
a plurality of monitors (160, 170); and
respective network interfaces (200) associated with each of the plurality of monitors; wherein:
each of the plurality of monitors transmits a respective request for viewing a respective channel via their respective network interface to the network interface associated with the tuning and decoding device;
the tuning and decoding device controls at least a subset of the plurality of tuning and decoding units, responsive to the respective requests, to tune and decode the respective channels; and
the tuning and decoding device couples (145) each of the plurality of monitors to a data stream that is output from the tuning and decoding unit which is being controlled to tune and decode the respective channel requested thereby.

18. A tuning and decoding device, comprising:
a plurality of tuning and decoding units (330, 335, 340), wherein each the tuning and decoding units is capable of performing tuning and decoding of a data stream (105) received by the tuning and decoding device;
a network interface (120); and
a processor (110); wherein:
the network interface receives, via a network (150), respective requests from each of a plurality of monitors (160, 170) for viewing a respective channel; and
the processor executes an algorithm for controlling at least a subset of the plurality of tuning and decoding units, responsive to the respective requests, to tune and decode the respective channels, and to couple (145) each of the plurality of monitors to a data stream that is output from the tuning and decoding unit which is being controlled to tune and decode the respective channel requested thereby.

19. The tuning and decoding device of claim 18, wherein:
the tuning and decoding device controls at least one of the tuning and decoding units that is not currently used to tune and decode any of the respective channels to predictively tune and decode a channel for at least one of the plurality of monitors.

20. A monitor, comprising:
a user interface (220) for receiving a user command to view a channel;
a processor (210);
a display (240); and
a network interface (200); wherein:
the processor is responsive to the user command received via the user interface for transmitting a request for viewing the channel via the network interface to a tuning and decoding device (100) via a network (150); and
the monitor receives (164) data of the channel from the tuning and decoding device and displays the data of the channel on the display.
